(19) United States
(12) Patent Application Publication
(10) Pub. No.: US 2026/0121461 A1
(43) Pub. Date: Apr. 30, 2026

(54) STATOR LINING, STATOR AND METHOD FOR PRODUCING A STATOR LINING

(71) Applicant: Ralf DAUNHEIMER, Schermbeck (DE)

(72) Inventor: Ralf DAUNHEIMER, Schermbeck (DE)

(21) Appl. No.: 19/483,397

(22) PCT Filed: Jun. 10, 2024
(86) PCT No.: PCT/EP2024/065922

§ 371 Date: Nov. 11, 2025

(30) Foreign Application Priority Data
Jun. 19, 2023 (DE) 102023115951.8

(51) Int. Cl. H02K 1/12; F04C 29/00; H02K 1/22; H02K 7/14

(52) U.S. Cl. CPC H02K 1/12; F04C 29/00; H02K 1/22; H02K 7/14

(57) ABSTRACT

A stator lining for a stator of an eccentric screw pump, including: a rotor-receiving space which is formed continuously on the stator lining; and at least one pressure chamber recess which is arranged radially outwardly at a distance from the rotor-receiving space and is radially outwardly open and/or at least one pressure chamber which is arranged radially outwardly at a distance from the rotor-receiving space and is formed completely within the stator lining; wherein the pressure chamber recess and/or the pressure chamber is/are connected so as to communicate with a pressure end region of the stator lining, and wherein the stator lining is made of a material selected from a group including at least one metal, at least one metal alloy and at least one plastics material or plastics composite material having a hardness value of at least 65 on the Shore D hardness scale.

### FIELD OF THE INVENTION

The invention relates to a stator lining for a stator of an eccentric screw pump, comprising a rotor receiving space that is formed axially continuously on the stator lining with respect to a central longitudinal axis of the stator lining, from a suction end region of the stator lining to a pressure end region of the stator lining, and at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely inside the stator lining, wherein the pressure chamber recess and/or the pressure chamber is/are communicatively connected to the pressure end region of the stator lining.

The invention furthermore relates to a stator for an eccentric screw pump, comprising at least one stator housing and at least one stator lining that is surrounded by the stator housing in a radially outwardly peripheral manner with respect to a central longitudinal axis of the stator.

Furthermore, the invention relates to a method for producing a stator lining for a stator of an eccentric screw pump, wherein the stator lining is produced having a rotor receiving space that is formed axially continuously on the stator lining with respect to a central longitudinal axis of the stator lining, from a suction end region of the stator lining to a pressure end region of the stator lining, and at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely inside the stator lining, such that the pressure chamber recess and/or the pressure chamber is/are communicatively connected to the pressure end region of the stator lining.

### BACKGROUND OF THE INVENTION

Eccentric screw pumps are conventionally used above all for conveying thick, highly viscous and abrasive conveying media. For this purpose, an eccentric screw pump comprises a stator and a rotor which is arranged rotatably in the stator and is generally driven at its suction-side end for operating the eccentric screw pump.

DE 20 2021 106 537 U1 discloses an eccentric screw pump comprising a rotor that forms a screw-conveyor and a stator that forms a screw channel in which the rotor revolves during conveying operation. The stator comprises a stator housing, in which a stator lining is located which forms the screw channel. The stator lining is a sleeve which is supported on its outer periphery, via a carrier structure that forms cavities, on the stator housing. The carrier structure is configured and dimensioned depending on the location of its connection to the sleeve in such a way that the support effect provided thereby is adjusted to the local requirements of the sleeve.

In order to be able to keep a return flow of a conveying medium from the pressure side to the suction side of the eccentric screw pump as low as possible, the stator lining can be produced having a certain excess with respect to the rotor, such the rotor elastically deforms the stator lining in a contact region therewith. However, owing to operation-induced movements of the rotor relative to the stator lining, abrasion or wear of the stator lining necessarily occurs. This reduces a contact force between the rotor and the stator lining, as a result of which a helically formed contact line between the rotor and the stator lining can be interrupted, which is associated with an increased return flow of the conveying medium and thus with a reduced effectiveness of the eccentric screw pump. In order to be able to counteract this, the stator lining or the entire stator must be exchanged, at regular time intervals, for a new stator lining or a new stator, which is associated with a standstill of the eccentric screw pump and maintenance costs.

EP 3 825 552 A1 discloses an eccentric screw pump having a rotor and a stator. The rotor comprises at least one elastomer portion, on which a pressure chamber is arranged on a side facing away from the rotor. The pressure chamber is connected to a pressure end region of the eccentric screw pump in such a way that the elastomer portion is exposed to a pressure generated by the eccentric screw pump, in order to be able to influence a contact pressure between the stator and the rotor.

### SUMMARY OF THE INVENTION

The object of the invention is that of providing a stator for an eccentric screw pump, by means of which a return flow of a conveying medium to the suction side of the eccentric screw pump can be minimised as far as possible, even in the case of relatively high conveying pressure loads.

This object is achieved by the independent patent claims. Advantageous embodiments are reproduced in the dependent patent claims, the following description, and the figures, wherein these embodiments can represent an advantageous and/or developmental aspect of the invention, taken in isolation in each case or combinations of at least two of said embodiments. In this case, advantageous embodiments of the stator lining and of the stator can correspond to advantageous embodiments of the method, and vice versa, even if reference is not explicitly made thereto in detail in the following.

A stator lining according to the invention for a stator of an eccentric screw pump comprises:
a rotor receiving space that is formed axially continuously on the stator lining with respect to a central longitudinal axis of the stator lining, from a suction end region of the stator lining to a pressure end region of the stator lining; and
at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely inside the stator lining;
wherein the pressure chamber recess and/or the pressure chamber is or are communicatively connected to the pressure end region of the stator lining, and
wherein the stator lining is formed from a material selected from a group including at least one metal, at least one metal alloy and at least one plastics material or plastics composite material having a hardness value of at least 65 on the Shore D hardness scale.

In the present application, the terms “axial(ly)” and “radial(ly)” refer throughout to the central longitudinal axis of the stator lining or of the stator.

In pumping operation of an eccentric screw pump equipped with a stator lining according to the invention, a pressurised conveying medium leaves the eccentric screw pump, which medium acts on the pressure end region of the stator lining. Since the pressure chamber recess or the pressure chamber is communicatively connected to the pressure end region of the stator lining, the pressurised conveying medium enters the pressure chamber recess or the pressure chamber and fills it completely. This makes it possible to reliably prevent the rotor receiving space from widening radially outwardly in the case of higher pressure loads, as a result of which a helical contact line between the rotor and the stator lining could be interrupted. This would be necessarily associated with a significantly increased return flow of the conveying medium to the suction end region of the stator lining, which should absolutely be avoided in order to increase the efficiency of a correspondingly equipped eccentric screw pump. Instead, the invention permanently ensures, even at very high pressures, for example in a range of 20 to 40 bar per stage of a correspondingly equipped eccentric screw pump, that a correspondingly equipped eccentric screw pump has a high level of tightness, in that the stator lining is in contact with the rotor with a virtually constant quality.

At least one pressure chamber recess can be formed, that is arranged so as to be radially outwardly spaced from the rotor receiving space and is configured to be open radially outwardly, which recess is communicatively connected to the pressure end region of the stator lining. The pressure chamber recess can be configured to be open at an outer lateral surface of the stator lining, i.e. can be formed at least in part as a depression on the outer lateral surface of the stator lining and extend radially inwards as far as to a spacing from the rotor receiving space. The pressure chamber recess I configured to be closed with respect to a suction end region, in particular with respect to an axial suction end face, of the stator lining. The pressure chamber recess can be communicatively connected, itself or via at least one channel formed on the stator lining, to the pressure end region of the stator lining. The pressure chamber recess can be communicatively connected to a portion, arranged in the suction end region, of an inner lateral surface of the stator lining that surrounds the rotor receiving space radially outwardly, and/or to a portion of the axial pressure end face of the stator lining.

In the case of a stator lining inserted in a stator housing, the pressure chamber recess is completely closed, radially outwardly, by a stator housing portion, such that a closed pressure chamber that is communicatively connected to the pressure end region of the stator lining is formed between the stator lining and the stator housing, in which chamber a pressure buildup, described above, can take place by introducing the conveying medium into the pressure chamber.

In this case, the pressure chamber recess can be formed entirely peripherally on the stator lining, such that the above-described pressure can act radially inwardly on the stator lining from all sides. Alternatively, two or more corresponding pressure chamber recesses can be formed peripherally offset from one another on the stator lining, which each extend over just part of the periphery of the stator lining, wherein these pressure chamber recesses can be arranged so as to be axially offset from one another, or not.

Alternatively or in addition, at least one pressure chamber that is arranged so as to be radially outwardly spaced from the rotor receiving space and is formed entirely inside the stator lining can be present within the stator lining, which chamber is communicatively connected to the pressure end region of the stator lining. In contrast to the pressure chamber recess described above, the pressure chamber is not configured to be open radially outwardly, but rather closed.

The pressure chamber is not configured to be open in particular at the suction end region, in particular an axial suction end face, of the stator lining. The pressure chamber can be communicatively connected, itself or via at least one channel formed on the stator lining, to the pressure end region of the stator lining. The pressure chamber can be communicatively connected to a portion, arranged in the suction end region, of an inner lateral surface of the stator lining that surrounds the rotor receiving space radially outwardly, and/or to a portion of the axial pressure end face of the stator lining.

In order that the above-described pressure can act radially inwardly, from all sides, on the stator lining or a portion of the stator lining arranged between the pressure chamber and the rotor receiving space, at least a part of the pressure chamber can be formed completely peripherally on the stator lining. Alternatively, to or more corresponding pressure chambers can be formed peripherally offset from one another on the stator lining, which chambers each extend over only a part of the periphery of the stator lining, wherein these pressure chambers can be arranged so as to be axially offset from one another, or not.

The rotor receiving space that extends axially continuously through the stator lining serves for receiving a rotor of the eccentric screw pump, and for this purpose comprises at least one screw channel or a screw contour which can be adjusted to the respective intended use of a correspondingly equipped eccentric screw pump and can furthermore be configured in a conventional manner for example.

According to the invention, the stator lining is formed from a material selected from a group containing at least one metal, at least one metal alloy and at least one plastics material or plastics composite material having a hardness value of at least 65 on the Shore D hardness scale. As a result, the stator lining is hard compared with an elastomer stator lining, and as a result substantially not elastically deformable. Specifically, an elastomer stator lining in particular has the disadvantage that a stator lining of this kind can collapse due to the differential pressure applied thereto, which prevents operation of a correspondingly equipped eccentric screw pump. Therefore, an elastomer stator lining can be used only at relatively low pressures, while the elastomer stator lining fails at higher pressures. In contrast, in the case of solid materials according to the invention, a higher pressure application is possible due to the higher strength, as a result of which a correspondingly equipped eccentric screw pump can be operated with higher pressures per stage of the eccentric screw pump, which is essentially required for many applications.

For example, a thermosetting or thermoplastic material can be used as the plastics material. For example, a fibre-reinforced or powder-reinforced plastics material can be used as the plastics composite material. A fibre-reinforced plastics material can comprise for example glass fibres, carbon fibres, ceramic fibres, aramid fibres, boron fibres, basalt fibres, steel fibres, natural fibres or nylon fibres as reinforcing fibres. The powder-reinforced plastics material can for example be a polyvinyl fluoride, a tetrafluoroethylene-hexafluoropropylene copolymer, a perfluoro alkoxy polymer or the like. The powder-reinforced plastics material can be provided with a carbon or graphite powder.

In the case of a plastics material or plastics composite material, this preferably has a hardness value of at least 65, preferably of at least 80, particularly preferably of at least 90, on the Shore D hardness scale.

For example aluminium or copper can be used as the metal for the stator lining. For example a steel, an aluminium alloy or a copper alloy can be used as metal alloys for the stator lining.

The stator lining according to the invention can for example be produced by injection moulding, additive production or mechanical material removal. The production of the stator lining can alternatively or additionally comprise a sintering process.

According to an advantageous embodiment, the pressure chamber recess is formed at least in part helically peripherally on the stator lining. As a result, the pressure chamber recess is on the one hand formed peripherally on the stator lining, and on the other hand extends over a part of the axial length of the stator lining. A winding direction (right-hand turn or left-hand turn) of the pressure chamber recess around the central longitudinal axis of the stator lining can be formed taking into account a winding direction of the screw contour on the inner lateral surface of the stator lining that surrounds the rotor receiving space. In particular, these winding directions can be the same. Two or more corresponding pressure chamber recesses can also e formed on the stator lining, which recesses can extend in parallel with one another, wherein two pressure chamber recesses arranged adjacently to one another can be separated from one another by a separating wall that is formed so as to extend helically.

According to a further advantageous embodiment, the stator lining comprises at least one inner lining portion which is arranged radially inwardly and which comprises the rotor receiving space, and at least one outer lining portion which is arranged radially outwardly with respect to the inner lining portion and via which the inner lining portion can be supported radially outwardly on a stator housing of the stator, wherein a depth of the pressure chamber recess varies according to an outer lateral surface of the inner lining portion, wherein the outer lateral surface of the inner lining portion corresponds to an enlargement of a screw contour on an inner lateral surface of the stator lining surrounding the rotor receiving space, and wherein the inner lining portion has a constant material thickness. Due to this design of the inner lining portion, said portion has substantially uniform stability properties over its axial length, which properties can be varied only by the geometry of the inner lining portion which is defined by the screw contour. The inner lining portion can be monolithically connected to the outer lining portion and in particular can consist in part or completely of the same material as the outer lining portion.

According to a further advantageous embodiment, the pressure chamber extends helically over a part of an axial length of the stator lining. In this case, a helix axis of the helix formed by the pressure chamber preferably coincides with the central longitudinal axis of the stator lining. Due to the helical design of the pressure chamber, said chamber is arranged in part or completely peripherally on the stator lining, in particular on its outer lining portion. Since the stator lining is closed at its axial suction end face, the pressure chamber ends at an axial spacing from the axial suction end face. The pressure chamber can for example be configured as a helical drilled hole having a circular cross-sectional area. Alternatively, the pressure chamber can have an elliptical, oval or polygonal cross-sectional area. A winding direction of the pressure chamber about the central longitudinal axis of the stator lining can be formed taking into account the winding direction of the screw contour on the inner lateral surface of the stator lining surrounding the rotor receiving space. In particular, these winding directions can be the same. Two or more corresponding pressure chambers can also be formed on the stator lining, which chambers can together form a double or multiple helix.

According to a further advantageous embodiment, the stator lining comprises at least two pressure chambers which are arranged so as to be radially outwardly spaced with respect to the rotor receiving space and are formed entirely within the stator lining, wherein a radially outwardly arranged pressure chamber has a larger cross-sectional area than a radially inwardly arranged pressure chamber. The radially inward inner pressure chamber can also be designed to be helical, such that said inner pressure chamber can also be formed in part or completely peripherally on the stator lining. Since the stator lining is closed at its axial suction end face, the inner pressure chamber ends at an axial spacing from the axial suction end face. The inner pressure chamber can for example be configured as a helical drilled hole having a circular cross-sectional area. Alternatively, the pressure chamber can have an elliptical, oval or polygonal cross-sectional area. A winding direction of the inner pressure chamber around the central longitudinal axis of the stator lining can be formed taking into account the winding direction of the screw contour on the inner lateral surface of the stator lining surrounding the rotor receiving space. In particular, these winding directions can be the same. Two or more corresponding inner pressure chambers can also be formed on the outer lining portion, which chambers together form a double or multiple helix.

According to a further advantageous embodiment, the pressure chamber recess and/or the pressure chamber is/are communicatively connected to an axial pressure end face of the stator lining. According thereto, the pressure chamber recess or the pressure chamber is not communicatively connected to the inner lateral surface of the stator lining that has the screw contour, but rather exclusively to the axial pressure end face of the stator lining. As a result, the pressure chamber recess or the pressure chamber is accessible without interruption, irrespective of a position of a rotor arranged in the rotor receiving space, in order to be able to ensure as uniform or uninterrupted as possible an application of pressure on the pressure chamber recess or the pressure chamber.

According to a further advantageous embodiment, the stator lining comprises at least one rotation prevention depression that is arranged on an outer lateral surface of the stator lining and extends over a part of the axial length of the stator lining, or at least one rotation prevention projection that is arranged on the outer lateral surface of the stator lining and extends over a part of the axial length of the stator lining. This makes it possible to prevent the stator lining from turning relative to a stator housing, about its central longitudinal axis, during operation of a correspondingly designed eccentric screw pump. For this purpose, at least one rotation prevention projection that can be introduced into the rotation prevention depression of the stator lining, or at least one rotation prevention depression that receives the rotation prevention projection of the stator lining, can be arranged on an inner lateral surface of the stator housing. This embodiment is advantageous in particular in the case of a circular-cylindrical design of the stator lining. The embodiment can be omitted if the outer lateral surface of the stator lining is designed to be polygonal, for example square, hexagonal or octagonal, in cross-section, which is possible in an alternative advantageous embodiment of the invention.

A stator according to the invention for an eccentric screw pump comprises at least one stator housing and at least one stator lining that is radially outwardly peripheral with respect to the central longitudinal axis of the stator and that is surrounded by the stator housing, wherein the stator lining is configured according to any of the above-mentioned embodiments or a combination of at least two of these embodiments.

The advantages mentioned above with respect to the stator lining are correspondingly associated with the stator. The stator housing is configured to be hollow-cylindrical and can have an annular or polygonal cross-sectional area. The stator housing can be produced in part or completely from a metal or a metal alloy. At least one mechanical interface, for example a connecting flange, for connecting the stator to a conveying medium supply unit of the eccentric screw pump can be present on a suction side of the stator housing, via which the conveying medium can be supplied to the stator. The stator lining is surrounded radially outwardly by the stator housing in such a way that the outer lateral surface of the stator lining is in contact with an inner lateral surface of the stator housing.

According to an advantageous embodiment, the stator housing has a retaining shoulder, configured radially inwardly and peripherally, on its axial pressure end face, on which shoulder the axial pressure end face of the stator lining rests axially. This prevents the stator lining from moving axially out of the stator housing during operation of a correspondingly equipped eccentric screw pump. The retaining shoulder is annular. The retaining shoulder extends radially inwardly to such an extent that the axial pressure end face of the stator lining is largely not covered by the retaining shoulder, in particular when the pressure chamber recess or the pressure chamber is communicatively connected to the axial pressure end face of the stator lining, in such a way as to prevent an opening on the axial pressure end face of the stator lining, via which the pressure chamber recess or pressure chamber is communicatively connected to the axial pressure end face of the stator lining, is concealed by the retaining shoulder.

According to a further advantageous embodiment, the stator comprises at least one securing ring, which can be inserted into a peripherally formed securing groove on an inner lateral surface of the suction end region of the stator housing, such that an axial suction end face of the stator lining rests axially on the securing ring. As a result, the stator lining is secured axially in the stator housing, on the suction side. If required, the stator lining can be serviced or exchanged for a new stator lining by removing the securing ring.

According to a further advantageous embodiment, at least one rotation prevention projection that engages in the rotation prevention depression of the stator lining, and/or at least one rotation prevention depression in which the rotation prevention projection of the stator lining engages, is or are arrange don an inner lateral surface of the stator housing. The advantages mentioned above with respect to the corresponding embodiment of the stator lining are correspondingly associated with this. The rotation prevention projection on the stator housing can for example be configured as a longitudinally extending bar.

According to a method according to the invention for producing a stator lining for a stator of an eccentric screw pump, the stator lining is produced having a rotor receiving space that is formed axially continuously on the stator lining with respect to a central longitudinal axis of the stator lining, from a suction end region of the stator lining to a pressure end region of the stator lining, and at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely inside the stator lining, such that the pressure chamber recess and/or the pressure chamber is or are communicatively connected to the pressure end region of the stator lining, wherein the stator lining is formed from a material selected from a group including at least one metal, at least one metal alloy and at least one plastics material or plastics composite material having a hardness value of at least 65 on the Shore D hardness scale.

The advantages mentioned above with respect to the stator lining or the stator are correspondingly associated with the method. In particular, a stator lining according to any of the above-mentioned embodiments or a combination of at least two of these embodiments together can be produced by means of the method.

The invention will be explained by way of example in the following, with reference to the accompanying figures and on the basis of preferred embodiments, wherein the features explained below can represent an advantageous and/or developmental aspect of the invention, both taken alone in each case and in various combinations with one another.

### BRIEF DESCRIPTION OF THE FIGURES

In the figures:

FIG. 1 is a schematic and perspective view of an embodiment for a stator according to the invention;

FIG. 2 is a further schematic and perspective view of the stator shown in FIG. 1;

FIG. 3 is a schematic front view of the stator shown in FIGS. 1 and 2;

FIG. 4 is a schematic longitudinal sectional view of the stator shown in FIG. 1 to 3, according to the sectional plane IV-IV from FIG. 3;

FIG. 5 is a schematic and perspective view of the stator lining of the stator shown in FIG. 1 to 4;

FIG. 6 is a schematic front view of the stator lining shown in FIG. 1 to 5;

FIG. 7 is a schematic side view of an inner lining portion of the stator lining shown in FIG. 1 to 6;

FIG. 8 is a schematic and perspective view of a further embodiment for a stator lining according to the invention;

FIG. 9 is a further schematic and perspective view of the stator lining shown in FIG. 8;

FIG. 10 is a schematic front view of the stator lining shown in FIGS. 8 and 9;

FIG. 11 is a further schematic front view of the stator lining shown in FIGS. 8 and 9; and

FIG. 12 is a schematic longitudinal sectional view of the stator lining shown in

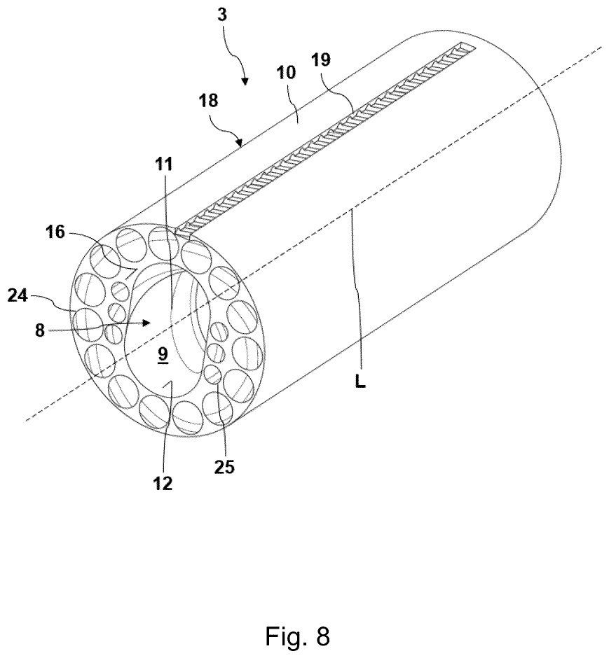

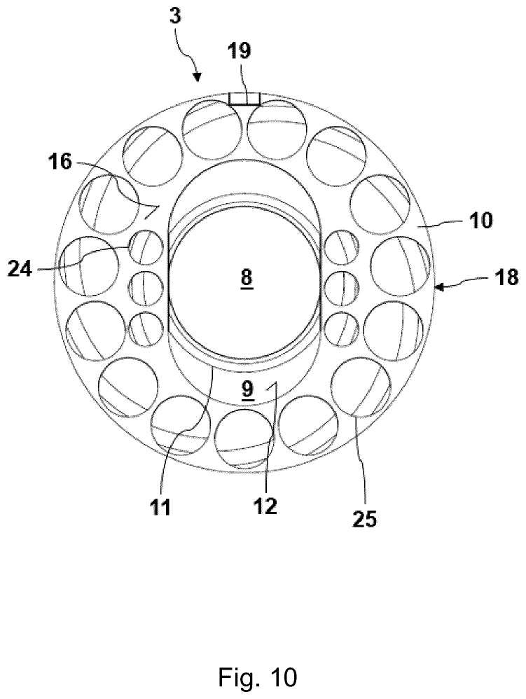

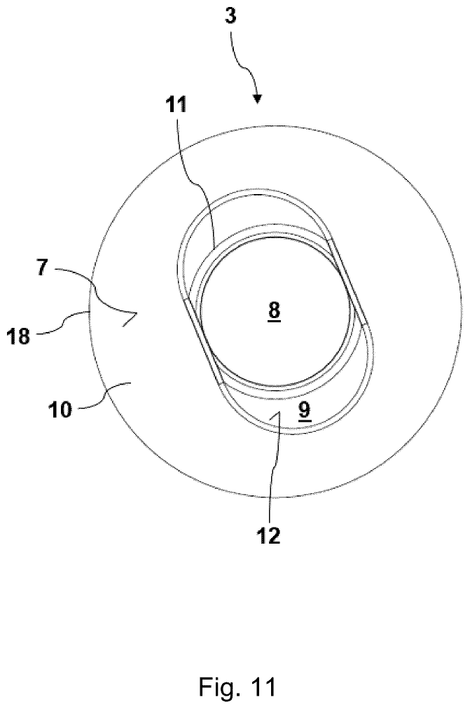

FIG. 8 to 11, according to the sectional plane XII-XII from FIG. 10.

### DETAILED DESCRIPTION OF THE INVENTION

In the figures, identical or functionally identical components are provided with the same reference signs. In order to avoid unnecessary repetitions, a repeated description of such components in detail can be omitted.

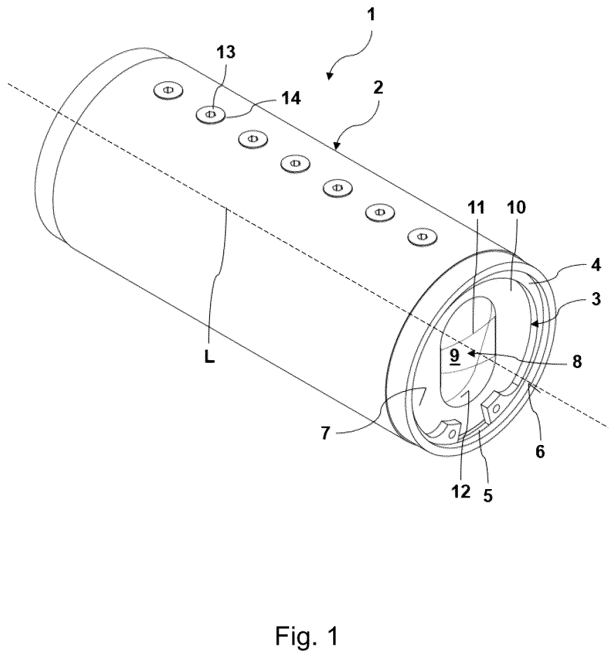

FIG. 1 is a schematic and perspective view of an embodiment for a stator 1 according to the invention for an eccentric screw pump (not shown). Inter alia an axial suction end face of the stator 1 is shown.

The stator 1 comprises a hollow-cylindrical stator housing 2 having an annular cross-sectional area. Furthermore, the stator 1 has a stator lining 3 that is surrounded in a radially outwardly peripheral manner by the stator housing 2, with respect to a central longitudinal axis L of the stator 1, which stator lining is substantially circular-cylindrical.

Furthermore, the stator 1 comprises a securing ring 4, which is inserted into a peripheral securing groove 5 on an inner lateral surface 6 of a suction end region of the stator housing 2, such that an axial suction end face 7 of the stator lining 3 rests axially on the securing ring 4.

The stator lining 3 comprises a rotor receiving space 8 that is formed axially continuously on the stator lining 3 with respect to a central longitudinal axis L of the stator lining 3, from a suction end region of the stator lining 3 facing the viewer of FIG. 1 to a pressure end region of the stator lining 3 facing away from the viewer of FIG. 1.

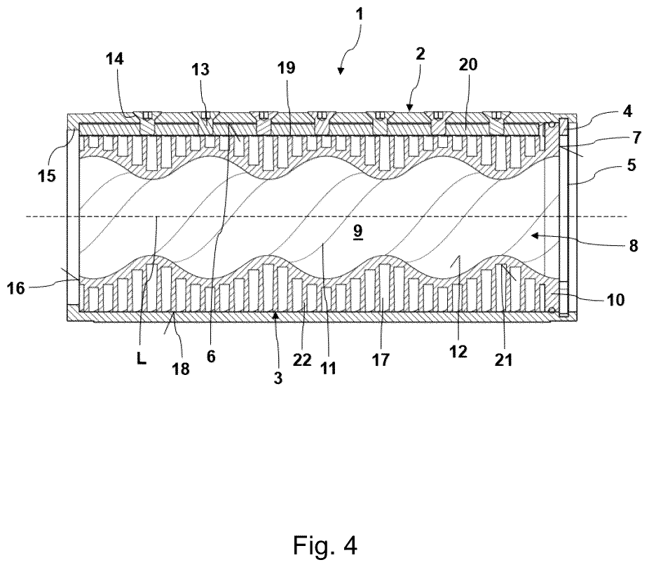

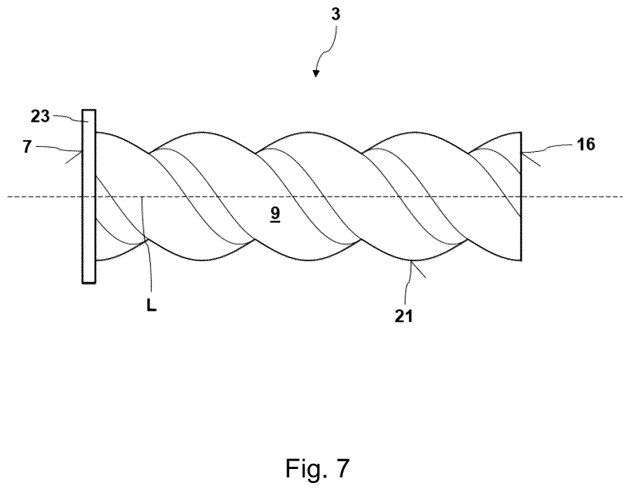

The stator lining 3 comprises a radially inwardly arranged inner lining portion 9 which comprises the rotor receiving space 8, and an outer lining portion 10 which is arranged radially outwardly with respect to the inner lining portion 9 and via which the inner lining portion 9 is supported radially outwardly on the stator housing 2. This is shown in particular in FIG. 4. The outer lateral surface of the inner lining portion 9, shown in particular in FIG. 7, corresponds to an enlargement of a screw contour 11 on an inner lateral surface 12 of the stator lining 13 that surrounds the rotor receiving space 8. In this case, the inner lining portion 9 has a constant material thickness, as is shown in particular in FIG. 4.

The stator lining 3 is formed from a material selected from a group including at least one metal, at least one metal alloy and at least one plastics material or plastics composite material having a hardness value of at least 65 on the Shore D hardness scale.

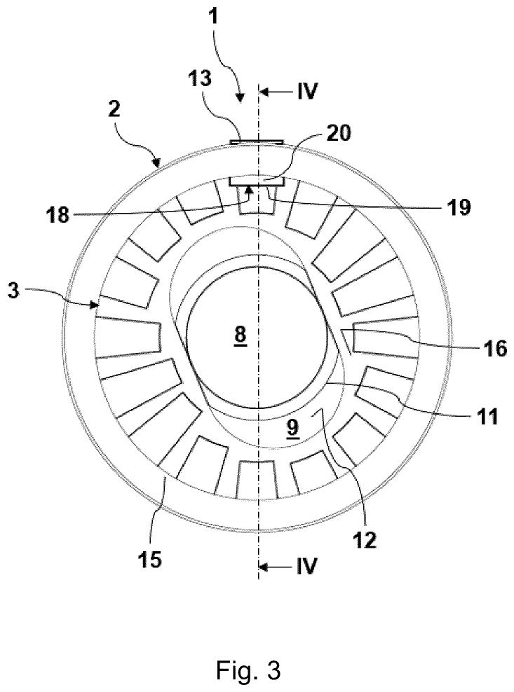

The stator lining 3 comprises a rotation prevention depression that is arranged on the outer lateral surface of the stator lining 3, shown in FIG. 3 to 6, and extends over a part of the axial length of the stator lining 3. A rotation prevention projection that engages in the rotation prevention depression of the stator lining 3 is arranged on an inner lateral surface of the stator housing 2 shown in FIG. 4. The rotation prevention projection is fixed to the stator housing 2 via seven screws 13 arranged in a row in parallel with the central longitudinal axis L of the stator 1 or the stator lining 3, which screws are guided through countersunk holes 14 of the stator housing 2 and are screwed into the rotation prevention projection, as is shown in FIG. 4.

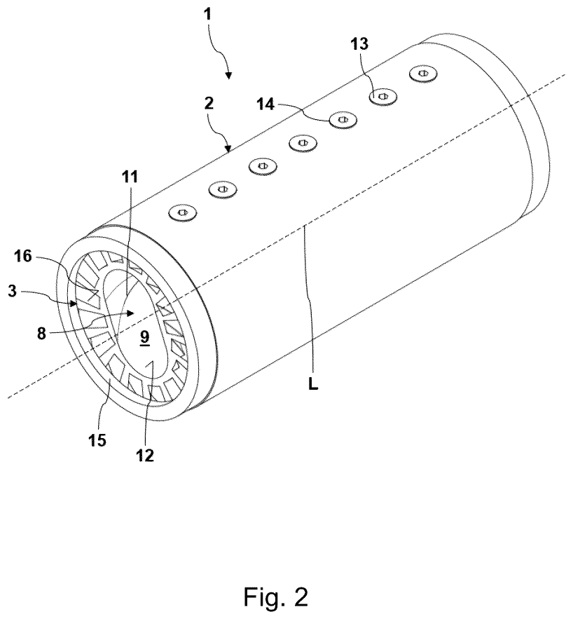

Further embodiments of the stator 1 are described in the following with reference to FIG. 2 to 7.

FIG. 2 is a further schematic and perspective view of the stator 1 shown in FIG. 1. Inter alia the axial pressure end face of the stator 1 is shown.

The stator housing 2 has a retaining shoulder 15, configured radially inwardly and peripherally, on its axial pressure end region that faces the viewer of FIG. 2, on which shoulder the axial pressure end face 16 of the stator lining 3, facing the viewer of FIG. 2, rests axially.

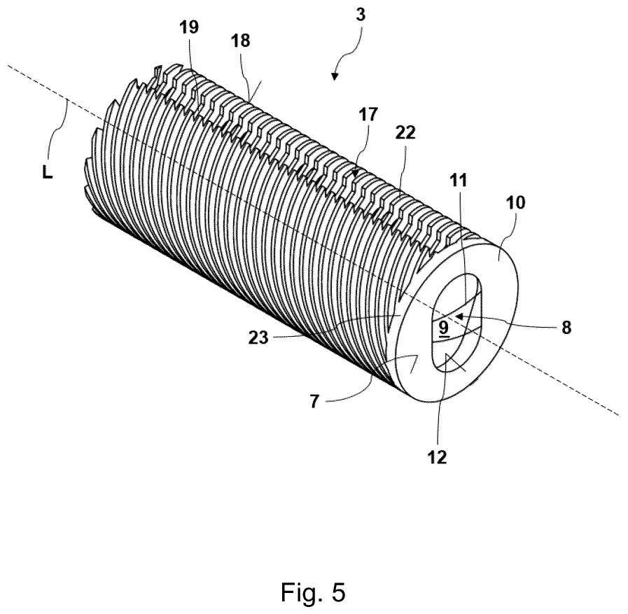

The stator 1 comprises a plurality of pressure chamber recesses 17 that are arranged so as to be radially outwardly spaced from the rotor receiving space 8 and are configured to be open radially outwardly, which recesses are in each case communicatively connected to the pressure end region of the stator lining 3 facing the viewer of FIG. 2. In particular, the pressure chamber recesses 17 are in each case communicatively connected to the axial pressure end face 16 of the stator lining 3. In this case, the respective pressure chamber recess 17 is formed helically peripherally on the stator lining 3, as is shown in particular in FIG. 5. A depth of the respective pressure chamber recess 17, given in the radial direction, varies corresponding to an outer lateral surface of the inner lining portion 9 shown in particular in FIGS. 4 and 7, which is shown in particular in FIG. 2 to 4 and 6. The pressure chamber recesses 17 are arranged so as to be peripherally offset from one another.

FIG. 3 is a schematic front view of the stator 1 shown in FIGS. 1 and 2, wherein the axial pressure end face of the stator 1 is shown.

The rotation prevention depression 19 of the stator lining 3 arranged on the outer lateral surface 18 of the stator lining 3 and extending over a part of the axial length of the stator lining 3 is shown. Furthermore, the rotation prevention projection 20 of the stator 1, which is arranged on the inner lateral surface, shown in particular in FIG. 4, of the stator housing 2 and engages in the rotation prevention depression 19 is shown.

FIG. 4 is a schematic sectional view of the stator 1 shown in FIG. 1 to 3, according to the sectional plane IV-IV from FIG. 3.

In particular, the way in which the bar-shaped rotation prevention projection 20 is fixed to the inner lateral surface 6 of the stator housing 2 by means of screws 13 is shown. It is furthermore shown that the outer lateral surface 21 of the inner lining portion 9 corresponds to an enlargement of the screw contour 11 on the inner lateral surface 12 of the stator lining 13 that surrounds the rotor receiving space 8, wherein the inner lining portion 9 has a constant material thickness for this purpose. It is furthermore shown that the depth of the respective pressure chamber recess 17 varies corresponding to the outer lateral surface 21 of the inner lining portion 9. Pressure chamber recesses 17 arranged adjacently to one another are separated from one another via a helically extending separating wall 22, which forms a part of the outer lining portion 10 of the stator lining 3.

FIG. 5 is a schematic and perspective view of the stator lining 3 of the stator shown in FIG. 1 to 4. In particular the helically extending pressure chamber recesses 17 and separating walls 22 are shown, wherein the pressure chamber recesses 17 end at a spacing from the axial suction end face 7 of the stator lining 3. In this case, the axial suction end face 7 is formed by a discoid axial end portion 23 of the stator lining 3. The rotation prevention depression 19 also ends at the axial end portion 23 and is configured to be axially open at its other end, at the axial pressure end face of the stator lining 3 facing away from the viewer of FIG. 5.

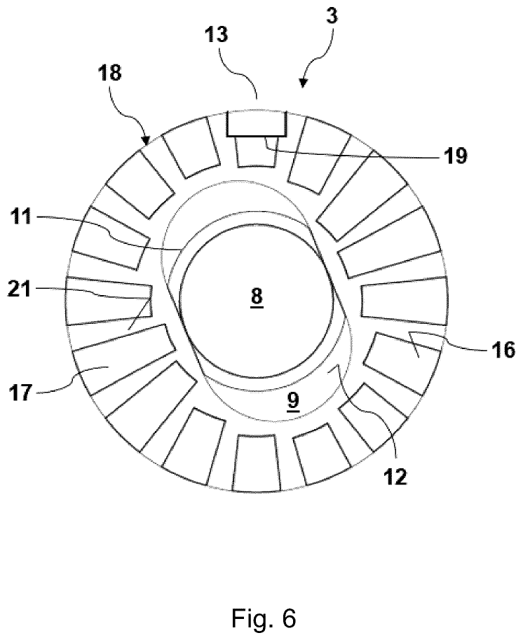

FIG. 6 is a schematic front view of the stator lining 3 shown in FIG. 1 to 5. The axial pressure end face 16 of the stator lining 3 is shown, at which the rotation prevention depression 19 and the pressure chamber recesses 17 end or open out.

FIG. 7 is a schematic side view of the inner lining portion 9 of the stator lining 3 shown in FIG. 1 to 6. The outer lining portion shown in FIG. 1 to 6 has been omitted, in order to be able to better show the embodiment of the inner lining portion 9. It is furthermore shown that the outer lateral surface 21 of the inner lining portion 9 is an enlargement of the screw contour shown in FIG. 1 to 6.

FIG. 8 is a schematic and perspective view of a further embodiment for a stator lining 3 according to the invention, for a stator (not shown) of an eccentric screw pump (not shown). The stator lining 3 can be combined together with the stator housing shown in FIGS. 1 and 4 to form a stator. Inter alia an axial pressure end face 16 of the stator lining 3 is shown, which faces the viewer of FIG. 8.

The stator lining 3 has a rotor receiving space 8 that is formed axially continuously on the stator lining 3 with respect to a central longitudinal axis L of the stator lining 3, from a suction end region of the stator lining 3 facing the viewer of FIG. 8 to a pressure end region of the stator lining 3 facing away from the viewer of FIG. 8.

The stator lining 3 has a radially inwardly arranged inner lining portion 9, which comprises the rotor receiving space 8, and an outer lining portion 10 which is arranged radially outwardly with respect to the inner lining portion 9 and via which the inner lining portion 9 can be supported radially outwardly on a stator housing (not shown). The outer lateral surface, shown in particular in FIG. 7, of the inner lining portion 9 corresponds to an enlargement of a screw contour 11 on an inner lateral surface 12 of the stator lining 3 that surrounds the rotor receiving space 8. In this case, the inner lining portion 9 has a constant material thickness.

The stator lining 3 is formed from a material selected from a group including at least one metal, at least one metal alloy and at least one plastics material or plastics composite material having a hardness value of at least 65 on the Shore D hardness scale.

A rotation prevention depression 19 which extends over part of the axial length of the stator lining 3 is arranged on an outer lateral surface 18 of the stator lining 3, which depression is formed so as to be axially open at the axial pressure end face 16 of the stator lining 3. The rotation prevention depression 19 is configured as a longitudinal slot, which ends at a spacing from the axial suction end face of the stator lining 3.

The stator lining comprises fifteen pressure chambers 24 which are arranged so as to be radially outwardly spaced from the rotor receiving space 8 and which are formed entirely within the stator lining 3, which are each communicatively connected to the pressure end region of the stator lining 3. In particular, the respective pressure chamber 24 is communicatively connected to the axial pressure end face 16 of the stator lining 3.

Each of the pressure chambers 24 extends helically over a part of an axial length of the stator lining 3. The pressure chambers 24 have a common helix axis, which is identical to the central longitudinal axis L of the stator lining 3, such that the pressure chambers 24 form a multiple helix. The pressure chambers 24 are arranged so as to be uniformly peripherally offset relative to one another. Each pressure chamber 24 has a circular cross-sectional area.

Furthermore, the stator lining comprises six pressure chambers 25 which are arranged so as to be radially outwardly spaced from the rotor receiving space 8 and which are formed entirely within the stator lining 3, which are arranged radially inwardly with respect to the pressure chambers 24. The radially outer pressure chambers 24 each have a larger cross-sectional area than a radially inner pressure chamber 25. In each case three radially inner pressure chambers 25 are arranged side-by-side in a row on mutually opposing sides of the rotor receiving space 8, and specifically in a region in which the stator lining 3 has a larger wall thickness.

The radially inner pressure chambers 25 are also each communicatively connected to the pressure end region of the stator lining 3. In particular, the respective radially inner pressure chamber 25 is communicatively connected to the axial pressure end face 16 of the stator lining 3.

Each of the radially inner pressure chambers 25 extends helically over a part of an axial length of the stator lining 3. The radially inner pressure chambers 25 have a common helix axis, which is identical to the central longitudinal axis L of the stator lining 3, such that the radially inner pressure chambers 25 also form a multiple helix. Each radially inner pressure chamber 25 has a circular cross-sectional area.

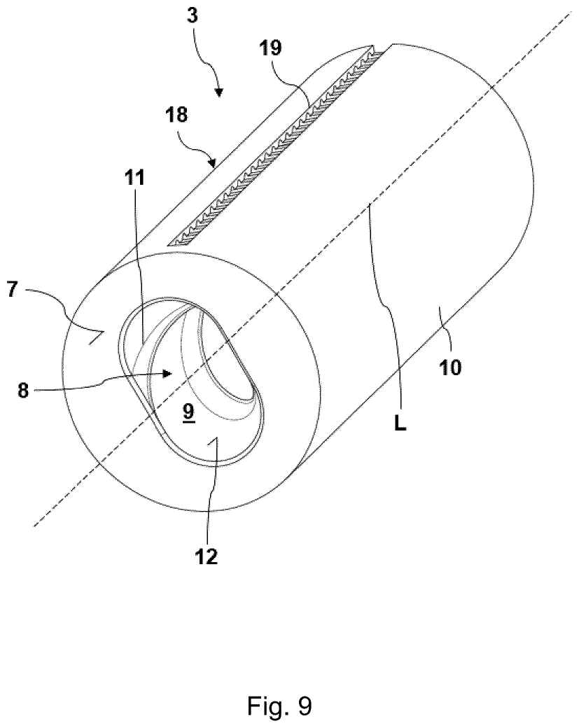

Further embodiments of the stator 1 are described in the following with reference to FIG. 9 to 12.

FIG. 9 is a further schematic and perspective view of the stator lining 3 shown in FIG. 8. Inter alia an axial suction end face 10 of the stator lining 3 is shown, which faces the viewer of FIG. 9.

FIG. 10 is a schematic front view of the stator lining 3 shown in FIGS. 8 and 9. Inter alia the axial pressure end face 16 of the stator lining 3 is shown, at which the pressure chambers 24 and 25 open out.

FIG. 22 is a further schematic front view of the stator lining 3 shown in FIGS. 8 and 9. Inter alia the axial suction end face 10 of the stator lining 3 is shown.

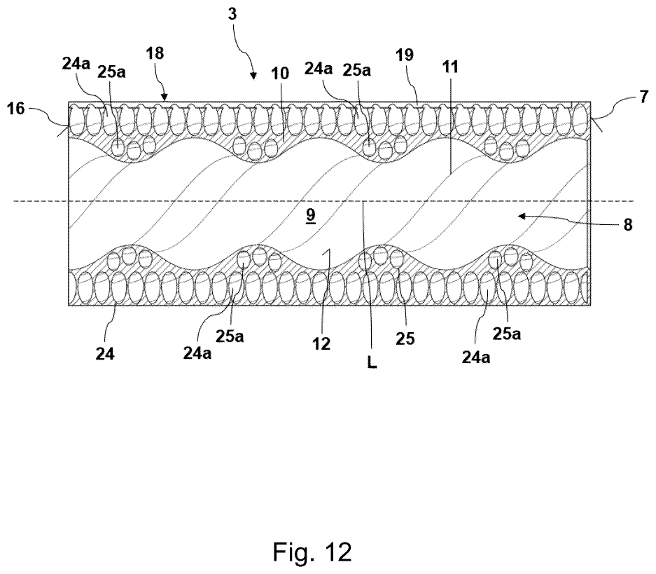

FIG. 12 is a schematic longitudinal sectional view of the stator lining 3 shown in FIG. 8 to 11, according to the sectional plane XII-XII from FIG. 10. The way in which the radially inner pressure chambers 25 wind through the stator lining 3 is shown using the example of a radially inner pressure chamber 25a. Furthermore, the way in which the radially outer pressure chambers 24 wind through the stator lining 3 is shown using the example of a radially outer pressure chamber 24a. The radially outer pressure chambers 24 or the walls that close said chambers radially outwardly protrude slightly into the rotation prevention depression 19, as a result of which a rib structure is formed in the rotation prevention depression 19, which is also shown in FIGS. 8 and 9.

In an alternative embodiment, the radially outer pressure chambers 24 do not protrude correspondingly into the rotation prevention depression 19, such that said depression has a smooth base.

### LIST OF REFERENCE SIGNS

1 stator
2 stator housing
3 stator lining
4 securing ring
5 securing groove
6 inner lateral surface of 2
7 axial suction end face of 3
8 rotor receiving space
9 inner lining portion
10 outer lining portion
11 screw contour
12 inner lateral surface of 9
13 screw
14 countersunk hole on 2
15 retaining shoulder
16 axial pressure end face of 3
17 pressure chamber recess
18 outer lateral surface of 3, 10
19 rotation prevention depression on 18
20 rotation prevention projection
21 outer lateral surface of 9
22 separating wall
23 axial end portion of 3
24 radially outer pressure chamber
25 radially inner pressure chamber
L central longitudinal axis of 1, 2, 3

What is claimed is:

1. A stator lining for a stator of an eccentric screw pump, comprising:
a rotor receiving space that is formed axially continuously on the stator lining with respect to a central longitudinal axis (L) of the stator lining, from a suction end region of the stator lining to a pressure end region of the stator lining; and
at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely inside the stator lining;
wherein the pressure chamber recess and/or the pressure chamber is/are communicatively connected to the pressure end region of the stator lining, and
wherein
the stator lining is formed from a material selected from a group including at least one metal, at least one metal alloy and at least one plastics material or plastics composite material having a hardness value of at least 65 on the Shore D hardness scale.

2. The stator lining according to claim 1, wherein the pressure chamber recess is formed at least in part helically peripherally on the stator lining.

3. The stator lining according to either claim 1, wherein at least one inner lining portion which is arranged radially inwardly and which comprises the rotor receiving space, and at least one outer lining portion which is arranged radially outwardly with respect to the inner lining portion and via which the inner lining portion can be supported radially outwardly on a stator housing of the stator, wherein a depth of the pressure chamber recess varies according to an outer lateral surface of the inner lining portion, wherein the outer lateral surface of the inner lining portion corresponds to an enlargement of a screw contour on an inner lateral surface of the stator lining that encloses the rotor receiving space, and wherein the inner lining portion has a constant material thickness.

4. The stator lining according to claim 1, that wherein the pressure chamber extends helically over a part of an axial length of the stator lining.

5. The stator lining according to claim 1, wherein at least two pressure chambers that are arranged so as to be radially spaced from the rotor receiving space and are formed entirely within the stator lining, wherein a radially outwardly arranged pressure chamber has a larger cross-sectional area than a radially inwardly arranged pressure chamber.

6. The stator lining according to claim 1, wherein the pressure chamber recess and/or the pressure chambers is/are communicatively connected to an axial pressure end face of the stator lining.

7. The stator lining according to claim 1, wherein at least one rotation prevention depression that is arranged on an outer lateral surface of the stator lining and extends over a part of the axial length of the stator lining, or at least one rotation prevention projection that is arranged on the outer lateral surface of the stator lining and extends over a part of the axial length of the stator lining.

8. A stator for an eccentric screw pump, comprising:
at least one stator housing and at least one stator lining that is surrounded by the stator housing in a radially outwardly peripheral manner with respect to a central longitudinal axis (L) of the stator, wherein the stator lining is configured according to claim 1.

9. The stator according to claim 8, wherein the stator housing comprises a radially inwardly and peripherally configured retaining shoulder on its pressure end region, on which shoulder the axial pressure end face of the stator lining rests axially.

10. The stator according to either claim 8, wherein at least one securing ring which can be inserted into a peripheral securing groove on an inner lateral surface of the suction end region of the stator housing, such that an axial suction end face of the stator lining rests axially on the securing ring.

11. The stator according to claim 8, wherein at least one rotation prevention projection that engages in the rotation prevention depression of the stator lining, and/or at least one rotation prevention depression, in which the rotation prevention projection of the stator lining engages, is or are arranged on an inner lateral surface of the stator housing.

12. A method for producing a stator lining for a stator of an eccentric screw pump, wherein the stator lining is produced having a rotor receiving space that is formed axially continuously on the stator lining with respect to a central longitudinal axis (L) of the stator lining, from a suction end region of the stator lining to a pressure end region of the stator lining, and at least one pressure chamber recess that is arranged so as to be radially outwardly spaced from the rotor receiving space and is configured to be open radially outwardly, and/or at least one pressure chamber that is arranged so as to be radially outwardly spaced from the rotor receiving space and is formed entirely within the stator lining, such that the pressure chamber recess and/or the pressure chamber is or are communicatively connected to the pressure end region of the stator lining,
wherein the stator lining is produced from a material selected from a group including at least one metal, at least one metal alloy and at least one plastics material or plastics composite material having a hardness value of at least 65 on the Shore D hardness scale.

13. The stator lining according to claim 2, wherein at least one inner lining portion which is arranged radially inwardly and which comprises the rotor receiving space, and at least one outer lining portion which is arranged radially outwardly with respect to the inner lining portion and via which the inner lining portion can be supported radially outwardly on a stator housing of the stator, wherein a depth of the pressure chamber recess varies according to an outer lateral surface of the inner lining portion, wherein the outer lateral surface of the inner lining portion corresponds to an enlargement of a screw contour on an inner lateral surface of the stator lining that encloses the rotor receiving space, and wherein the inner lining portion has a constant material thickness.

14. The stator lining according to claim 4, wherein at least two pressure chambers that are arranged so as to be radially spaced from the rotor receiving space and are formed entirely within the stator lining, wherein a radially outwardly arranged pressure chamber has a larger cross-sectional area than a radially inwardly arranged pressure chamber.

15. The stator lining according to claim 5, wherein the pressure chamber recess and/or the pressure chambers is/are communicatively connected to an axial pressure end face of the stator lining.

16. The stator lining according to claim 15, wherein at least one rotation prevention depression that is arranged on an outer lateral surface of the stator lining and extends over a part of the axial length of the stator lining, or at least one rotation prevention projection that is arranged on the outer lateral surface of the stator lining and extends over a part of the axial length of the stator lining,

17. The stator according to claim 9, wherein at least one securing ring which can be inserted into a peripheral securing groove on an inner lateral surface of the suction end region of the stator housing, such that an axial suction end face of the stator lining rests axially on the securing ring.

18. The stator according to claim 17, wherein at least one rotation prevention projection that engages in the rotation prevention depression of the stator lining, and/or at least one rotation prevention depression, in which the rotation prevention projection of the stator lining engages, is or are arranged on an inner lateral surface of the stator housing.
